(19) United States
(12) Patent Application Publication
(10) Pub. No.: US 2019/0255922 A1
(43) Pub. Date: Aug. 22, 2019

(54) Polymer Profile Frame for Vehicle Window Unit

(71) Applicant: Central Glass Company, Limited, Yamaguchi (JP)

(72) Inventor: Issam Sabra, Grevenmacher (LU)

(21) Appl. No.: 16/303,348

(22) PCT Filed: Mar. 29, 2017
(86) PCT No.: PCT/JP2017/012831

§ 371 Date: Nov. 20, 2018

(30) Foreign Application Priority Data
Jun. 7, 2016 (GB) 1609946.7

(51) Int. Cl. B60J 10/21; B60J 10/18; B60J 10/70; B60J 10/34; B60J 1/00

(52) U.S. Cl. CPC B60J 10/21; B60J 10/18; B60J 1/00; B60J 10/34; B60J 10/70

(57) ABSTRACT

A polymer profile frame (1) for a vehicle window unit (12), includes a base portion (3), a flexible lip (4) extending out from and alongside the base portion (3), and at least one bend portion (5) that is to be applied to a corner portion of a window glass substrate (2). The bend portion (5) includes a V-shaped notch (7) that is formed so as to extend completely through the base portion (3) but only part-way through the flexible lip (4), thereby leaving a residual lip portion (45) next to the notch (7). A flexible linear member (6) is integrally molded into the profile within the lip area. Tearing at the bend portion (5) can then be prevented.

### FIELD OF DISCLOSURE

The invention relates to a polymer frame or profile frame to be attached to an edge portion of a vehicle window, and to a vehicle window unit comprising such profile frame attached to a glass window substrate.

### BACKGROUND OF THE INVENTION

In many cases, fixed sash windows installed in vehicle have a polymer frame at the edge portion of the window. The polymer frame has a flexible lip or a fastener extending out from and alongside a base portion of the polymer frame. The flexible lip or the fastener provides a water-sealing structure to a fixed sash window when installed in a vehicle.

JP examined utility model publication H07-50250 Y2 discloses a bendable polymer profile frame with a fastener having a metal wire inserted into a hole within the bottom portion of the fastener so as to extend in longitudinal direction of the fastener. U.S. Pat. No. 6,513,854 discloses a polymer profile frame with a lip. The frame comprises a bend portion that may be applied to a corner portion of a window. The bend portion comprises a V-shaped notch area that allows the frame to easily fit to the corner portion.

### BRIEF SUMMARY OF THE EXEMPLARY EMBODIMENTS

The polymer profile frame disclosed in U.S. Pat. No. 6,513,854 has disadvantages for fitting the frame to a corner portion of a window. The V-shaped notch area is formed so as to extend completely through the base portion of the frame and part-way through the lip. Thus, a residual lip portion of the bend portion then becomes narrow. Since the lip is required to be of a soft material, to provide a water proof structure in a window unit installed in a vehicle, the bend portion is liable to tearing while handling the frame. In addition, shrinkage of the profile material can generate through aging of the glass unit, again resulting in tearing at the bend portion.

It is an aim herein to provide a new and useful polymer profile frame for vehicle window units, especially in view of the drawbacks mentioned above.

According to one aspect of the present invention, there is provided a polymer profile frame for a vehicle window unit, comprising:
a base portion,
a flexible lip extending along and out from the base portion, and
at least one bend portion to be applied to a corner portion of a window substrate,

wherein the bend portion has a V-shaped notch formed so as to completely through the base portion and part-way through the flexible lip, thereby leaving a residual lip portion adjacent the notch (“residual lip portion adjacent the notch” is expressed simply as “residual lip portion” below),

wherein the residual lip portion comprises a flexible linear member integrally molded within the residual lip portion.

Furthermore, according to a second aspect of the present invention, there is provided a vehicle window unit, comprising a glass substrate and a polymer profile frame applied on an edge portion of the glass substrate which as at least one corner portion,
wherein the polymer profile frame comprises:
a base portion,
a flexible lip extending along and out from the base portion, and
at least one bend portion applied to the corner portion of the glass substrate,
wherein the bend portion has a V-shaped notch formed so as to extend completely through the base portion and part-way through the flexible lip, and the bend portion has a residual lip portion, outside the notch, having a flexible linear member integrally molded within the residual lip portion.

A further aspect of the invention is a method of making such a window unit comprising attaching the profile frame along the edge of the glass substrate, preferably by adhesive, aligning the notch area with a corner portion of the substrate and closing the V-shaped notch together at the corner portion for the profile frame to conform to the edge of the glass substrate.

### Advantageous Effect of the Invention

By the frame having the above structure, tearing at the bend portion can be prevented while the frame is handled. In the glass unit, tearing at the bend portion can be prevented even when shrinkage of the profile material arises through aging of the glass unit.

### BRIEF DESCRIPTION OF DRAWINGS

FIG. 1 is a schematic view showing a main part of a polymer profile frame embodying the present invention;

FIG. 2 is a cross-section of FIG. 1 at A-A;

FIG. 3 is a view similar to FIG. 2, but showing another embodiment of polymer profile frame in the present invention;

FIG. 4 is a schematic view showing part of a vehicle window unit embodying the invention;

FIG. 5 is a cross-section at B-B of FIG. 4, showing the frame of FIG. 2;

FIG. 6 is a view similar to FIG. 5, but showing the frame of FIG. 3; and

FIG. 7 is a view similar to FIG. 1, but showing a main part of another embodiment of polymer profile frame.

### DETAILED DESCRIPTION OF THE EXEMPLARY EMBODIMENTS

In the following description, for purposes of explanation and not limitation, specific details are set forth in order to provide understanding of certain embodiments of the present invention. However, it will be apparent to those skilled in the art that the present invention may be practiced in other embodiments that depart from these specific details. In other instances, detailed descriptions of well known devices, processes, techniques, and methods are omitted so as to not obscure the description with unnecessary details. We refer now more particularly to the accompanying drawings, in which like reference numerals indicate like parts/elements throughout several views.

For better understanding of the present invention, the present invention is described using figures.

In accordance with typical embodiments of the present invention, a polymer profile frame 1 is formed via extrusion (the term “extrusion” as used herein includes both extrusion and coextrusion). Following extrusion, the profile frame 1 may be stored, may be cut into units of a select length, may be trimmed, may be allowed to cure (fully or partially), and so forth in accordance with established knowledge. Thereafter, the profile frame 1 is applied and attached to a surface(s) extending along an edge portion 21 of a window (same as glass substrate 2) along at least two consecutive sides thereof and at least one corner portion between the sides, resulting in vehicle window unit 12 (see FIGS. 4-6).

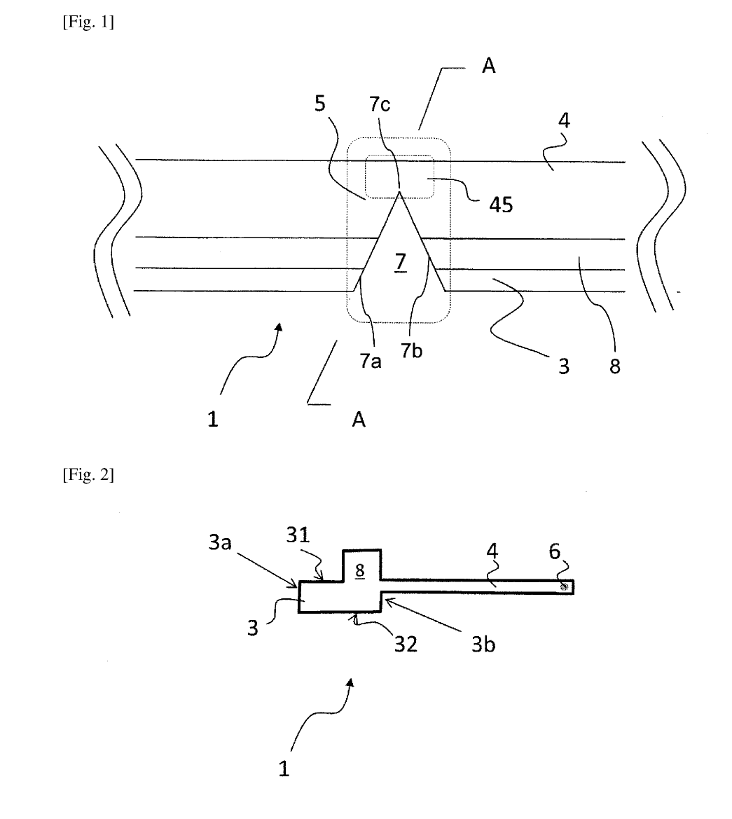

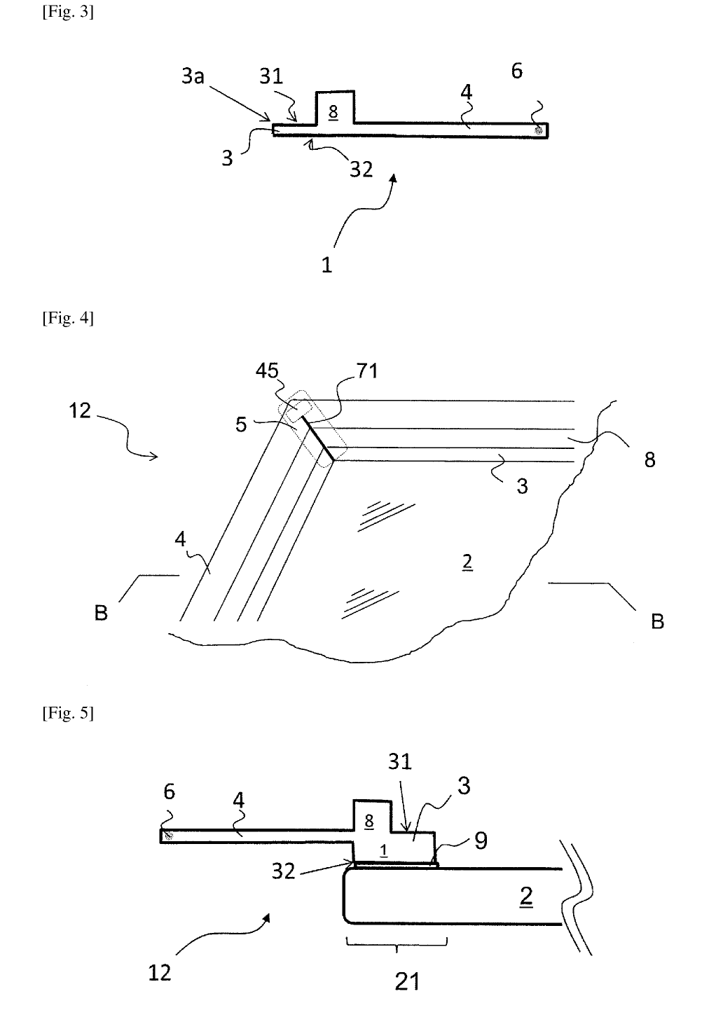

The polymer profile frame 1 comprises, in terms of cross-section shown in FIG. 2 or FIG. 3, a base portion 3 and a flexible lip 4 extending alongside and outwardly from the base portion 3. In terms of the longitudinal features, the profile frame also has at least one bend portion 5 (see FIG. 1). Each bend portion 5 is adapted to be applied to a corresponding corner portion of the glass substrate or window, forming a closed notch 71 at the bend portion 5 as shown in FIG. 4. When the window unit 12 is installed in vehicle into a fixed sash window, the flexible lip 4 can provide a water-sealing structure for the fixed sash window. In a typical construction, the base portion 3 has a flat undersurface region for attaching to the surface of the glass substrate, directly or indirectly, usually by adhesive means such as adhesive or double-sided tape applied thereto. The flexible lip 4 can project out from the base portion 3 beyond the edge of the glass substrate that may be generally parallel to the substrate surface, when the profile frame is attached thereto, to engage and seal against an adjacent component of the vehicle.

A soft polymer material is preferably used as the material of the base portion 3, the flexible lip 4 and the bend portion 5. As examples of the soft polymer material, there can be mentioned thermoplastic rubbers (TPR), thermoplastic urethanes, thermoplastic olefins (TPO), thermoplastic elastomers (TPE), ethylene-propylene-diene monomer rubbers (EPDM), polyvinyl chloride (PVC), etc. The same material may be used to form the base portion 3, the flexible lip 4 and the bend portion 5.

The thickness i.e. the distance from a first (e.g. upper) main surface 31 to a second (e.g. lower) main surface 32 of the base portion 3 may be e.g. from 1 mm to 7 mm (see FIGS. 2, 3). The width i.e. the distance from one side (inner side) 3a to the other side 3b (outer side) of the base portion 3 may be e.g. from 4 mm to 12 mm. The thickness of the flexible lip 4 may be e.g. from 0.7 mm to 1.5 mm. The width or projection extent of the flexible lip 4 may be e.g. from 5 mm to 10 mm. In the case that there is no clear boundary between the base portion 3 and flexible lip 4, such as in the case of FIG. 3 or FIG. 6, the width of the base portion 3 and the lip 4 combined can be considered. This combined width may be e.g. from 8 mm to 22 mm. The numerical values may be determined depending on the vehicle and window shape.

The base portion 3 comprises the first main surface 31 and the second main surface 32. The base portion may comprise an upstanding rib 8 disposed on the first main surface 31 and extending along the base portion 3, to reinforce the base portion 3. The thickness of the rib 8 may be e.g. from 2 mm to 6 mm, and the width of the rib 8 may be e.g. from 1 mm to 6 mm. The numerical values may be determined depending on vehicle shape. As a material of the rib 8, TPR, thermoplastic urethane, TPO, TPE, EPDM, PVC etc. can be used. The same material may be used to form the base portion 3 and the rib 8.

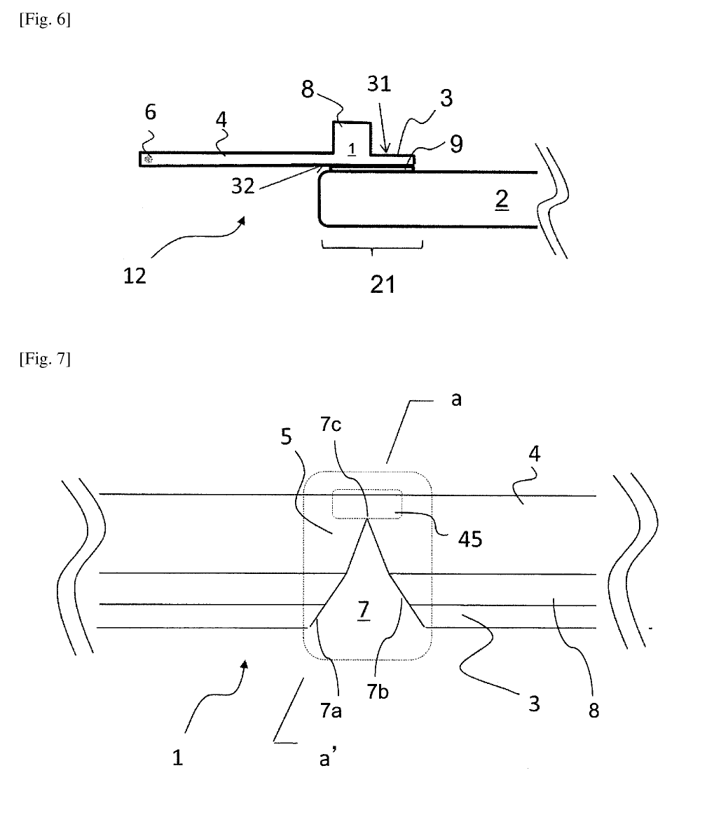

The profile frame 1 may be adhered to the glass substrate 2 through an adhesion layer 9 (see FIGS. 5, 6) between the glass substrate 2 and the second main surface 32 of the base portion 3 of the profile frame 1. In other words, the second main surface 32 can be or provide an adhesion layer-receiving area. It is preferred that the profile frame 1 is adhered to the glass substrate 2 after an adhesion layer 9 is formed on the second main surface 32. The adhesion layer 9 may be e.g. a double-sided adhesive tape, a glue such as thermo-reactive glue, etc. in accordance with the skilled person's knowledge.

The bend portion 5 comprises (see FIG. 1) a V-shaped notch 7, a residual lip portion 45 immediately outside the notch 7, and a flexible linear member 6 (see FIGS. 2, 3) integrally molded within the residual lip portion 45. The profile frame 1 is cut (but not all the way across or through the profile) from the inner side 3a of the base portion 3 (see FIGS. 2, 3) so as to form the V-shaped notch 7. The V-angle of the notch 7 may be adjusted depending on the angle of the corner portion(s) of the glass substrate 2 First and second surfaces 7a, 7b defining the V-shape of the notch 7 may respectively and entirely extend straight from their nodal line 7c, as shown in FIG. 1. More preferably, these first and second surfaces 7a, 7b may respectively extend straight from their nodal line 7c and then respectively outwardly flex at the boundary between the base portion 3 or rib 8 and flexible lip 4, as shown in FIG. 7. Applying a polymer profile frame 1 having such structure to a glass substrate 2, a tension can generate at the residual lip area 45 and this may improve a water-sealing property of the structure of the fixed sash window (vehicle window unit 12) installed in a vehicle.

The flexible linear member 6 may be integrally molded within the residual lip portion 45 along the edge of the flexible lip 4. The flexible linear member 6 may be molded-in when the polymer profile frame 1 is formed via extrusion. Preferably the flexible linear member 6 is integrally molded within the edge portion of the lip so as to extend in the longitudinal direction of the flexible lip 4, i.e., along the profile form, and more preferably, all the way along the profile i.e. not only at the bend portion 5. In the preferred embodiment, the bend portion 5 can then be efficiently formed.

The flexible linear member 6 can prevent the residual lip portion 45 from tearing arising from handling the frame 1 or through aging of the glass unit 12. For that purpose, as a material of the flexible linear member 6, materials that show higher resistance to shear stress than the lip 4 may be used. From this viewpoint, textile, glass fiber, or metallic wire may suitably be used as the flexible linear or elongate member 6. A skilled person may select an appropriate material to provide a reinforcement cord or tensile reinforcement incorporated into the structure of the lip. The diameter or thickness of the flexible linear member 6 may be e.g. from 0.1 mm to 1 mm. The numerical values may be determined depending on thickness of the lip 4. It may be a monofilament or composite element.

In the residual lip portion 45, the distance between the edge of the lip 4 and the end (i.e. nodal line 7c between the first and second surfaces 7a, 7b) of the notch 7 may usually be from 1 mm to 7 mm. In the case of smaller than 1 mm, it can become difficult to produce such a structure. On the other hand, in the case of larger than 7 mm, at the state that the residual lip portion 45 is bent, wrinkles might generate at the portion. Considering these issues, this distance may more preferably be from 2 mm to 6 mm.

1. A polymer profile frame for a vehicle window unit, comprising:
a base portion;
a flexible lip extending along and out from the base portion; and
at least one bend portion to be applied at a corner portion of a window substrate,
wherein the at least one bend portion has a V-shaped notch formed so as to extend completely through the base portion and part-way through the flexible lip, thereby leaving a residual lip portion adjacent the notch,
wherein the residual lip portion comprises a flexible linear member integrally molded within the residual lip portion.

2. The polymer profile frame according to claim 1, wherein, in the residual lip portion, a distance between an edge of the residual lip portion and an end of the notch is 1 mm to 7 mm.

3. The polymer profile frame according to claim 1, wherein the flexible linear member is a textile, a glass fiber, or a metallic wire.

4. The polymer profile frame according to claim 1, wherein the flexible linear member is integrally molded within an edge portion of the residual lip portion so as to extend in a longitudinal direction of the residual lip portion.

5. The polymer profile frame according to claim 4, wherein the flexible linear member is incorporated into the edge portion of the residual lip portion all along the polymer profile frame.

6. The polymer profile frame according to claim 1, wherein the base portion comprises:
a first main surface,
a second main surface, opposed to the first main surface, the second main surface being applied onto a surface of the window substrate, and
a rib disposed on the first main surface and extending along the base portion.

7. The polymer profile frame according to claim 1, wherein a main surface of the base portion provides an adhesion layer-receiving area for attachment to the window substrate.

8. The polymer profile frame according to claim 1, wherein first and second surfaces defining a V-shape of the notch respectively extend straight from a nodal line therebetween and respectively outwardly flex at a boundary between the base portion and the flexible lip.

9. A vehicle window unit, comprising a glass substrate and a polymer profile frame applied on an edge portion of the glass substrate which has at least one corner portion,
wherein the polymer profile frame comprises:
a base portion,
a flexible lip extending along and out from the base portion, and
at least one bend portion applied to the corner portion of the glass substrate,
wherein the at least one bend portion has a V-shaped notch formed so as to extend completely through the base portion and part-way through the flexible lip, and the at least one bend portion has a residual lip portion, outside the notch, having a flexible linear member integrally molded within the residual lip portion.

10. The vehicle window unit according to claim 9, wherein, in the residual lip portion, a distance between an edge of the residual lip portion and an end of the notch is 1 mm to 7 mm.

11. The vehicle window unit according to claim 9, wherein
the flexible linear member is a textile element, a glass fiber, or a metallic wire.

12. The vehicle window unit according to claim 9, wherein the flexible linear member is integrally molded within an edge portion of the residual lip portion so as to extend in a longitudinal direction of the residual lip portion.

13. The vehicle window unit according to claim 9, wherein the base portion comprises:
a first main surface,
a second main surface opposed to the first main surface, the second main surface being applied onto a surface of the glass substrate, and
a rib disposed on the first main surface and extending along the base portion.

14. The vehicle window unit according to claim 9, wherein the window unit comprises further comprising an adhesion layer between the glass substrate and a surface of the base portion, thereby attaching the polymer profile frame to the glass substrate.

15. The vehicle window unit according to claim 9, wherein first and second surfaces defining a V-shape of the notch respectively extend straight from a nodal line there between and respectively outwardly flex at a boundary between the base portion and the flexible lip.
